(19) United States
(12) Patent Application Publication
(10) Pub. No.: US 2023/0170465 A1
(43) Pub. Date: Jun. 1, 2023

(54) ALKALINE BATTERY AND METHOD OF MANUFACTURING ALKALINE BATTERY

(71) Applicant: MURATA MANUFACTURING CO., LTD., Kyoto (JP)

(72) Inventor: Masato YAMADA, Kyoto (JP)

(21) Appl. No.: 18/090,190

(22) Filed: Dec. 28, 2022

Related U.S. Application Data
(63) Continuation of application No. PCT/JP2021/035236, filed on Sep. 27, 2021.

(30) Foreign Application Priority Data
Oct. 30, 2020 (JP) 2020-182705

(51) Int. Cl. H01M 4/24; H01M 4/26; H01M 10/26; H01M 10/28

(52) U.S. Cl. CPC H01M 4/244; H01M 4/26; H01M 10/26; H01M 10/28; H01M 2004/027

(57) ABSTRACT

An alkaline battery includes a negative electrode. The negative electrode includes a negative electrode active material particle. The negative electrode active material particle includes a center part, a covering layer, and island-form layers. The center part includes zinc as a constituent element. The covering layer covers a surface of the center part and includes gallium as a constituent element. The island-form layers are present on a surface of the covering layer and include indium as a constituent element.

### CROSS REFERENCE TO RELATED APPLICATIONS

The present application is a continuation of PCT patent application no. PCT/JP2021/035236, filed on Sep. 27, 2021, which claims priority to Japanese patent application no. JP 2020-182705, filed on Oct. 30, 2020, the entire contents of which are herein incorporated by reference.

### BACKGROUND

The present technology relates to an alkaline battery and a method of manufacturing an alkaline battery.

An alkaline battery has been widely used in a device such as a portable game machine, a clock, or an electronic calculator. A configuration of the alkaline battery to be used in such a device has been considered in various ways.

Specifically, in order to improve a capacity utilization rate of a liquid-injection-type metal-air battery, a coating layer is provided on a surface of a negative electrode. The negative electrode is mainly composed of a metal that has a higher ionization tendency than hydrogen. The coating layer suppresses a hydrogen generating reaction between such a negative electrode and an electrolytic solution. In order to improve performance of a zinc alkaline battery, a gel negative electrode is used. The gel negative electrode includes mercury-free and lead-free zinc alloy powder to which indium is added. [0004] In order to manufacture negative electrode zinc alloy powder for an alkaline dry battery that is usable without applying an amalgamation process, indium and gallium are dry-added to a surface of zinc power in an inert gas atmosphere. In order to avoid liquid leakage of an alkaline manganese dry battery, a gallium oxide is included in an alkaline electrolytic solution such as a potassium hydroxide aqueous solution. In order to improve a storage characteristic of an alkaline battery, a predetermined amount of indium is present on surfaces of negative electrode active material particles that include zinc.

### SUMMARY

The present technology relates to an alkaline battery and a method of manufacturing an alkaline battery.

Consideration has been given in various ways of various characteristics of a battery such as an alkaline battery; however, the alkaline battery still remains insufficient in a heavy load characteristic. Accordingly, there is still room for improvement in terms thereof.

It is therefore desirable to provide an alkaline battery that is able to achieve a superior heavy load characteristic and a method of manufacturing such an alkaline battery.

An alkaline battery according to an embodiment includes a negative electrode. The negative electrode includes a negative electrode active material particle. The negative electrode active material particle includes a center part, a covering layer, and island-form layers. The center part includes zinc as a constituent element. The covering layer covers a surface of the center part and includes gallium as a constituent element. The island-form layers are present on a surface of the covering layer and include indium as a constituent element.

A method of manufacturing an alkaline battery according to an embodiment includes, in forming a negative electrode including a negative electrode active material particle, mixing a particle, an alkaline electrolytic solution, a thickener, and a liquid metal alloy with each other. The particle includes zinc as a constituent element. The alkaline electrolytic solution includes an aqueous solution including an alkali metal hydroxide. The thickener includes a polymer compound. The liquid metal alloy includes gallium and indium as constituent elements.

According to the alkaline battery of an embodiment, the negative electrode active material particle of the negative electrode includes the center part including zinc as a constituent element, the covering layer including gallium as a constituent element, and the island-form layers including indium as a constituent element. This makes it possible to achieve a superior heavy load characteristic.

According to the method of manufacturing an alkaline battery of an embodiment, the particle including zinc as a constituent element, the alkaline electrolytic solution including the aqueous solution including the alkali metal hydroxide, the thickener including the polymer compound, and the liquid metal alloy including gallium and indium as constituent elements are mixed with each other. This makes it possible to manufacture an alkaline battery having a superior heavy load characteristic.

Note that effects of the present technology are not necessarily limited to those described herein may include any of a series of suitable effects.

FIG. 1 is a sectional diagram illustrating a configuration of an alkaline battery according to one embodiment of the technology.

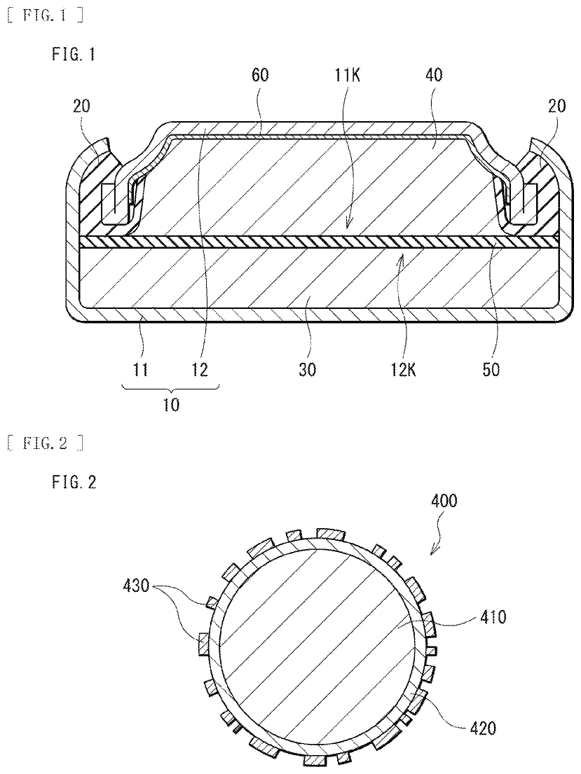

FIG. 2 is a sectional diagram schematically illustrating a configuration of a negative electrode active material particle.

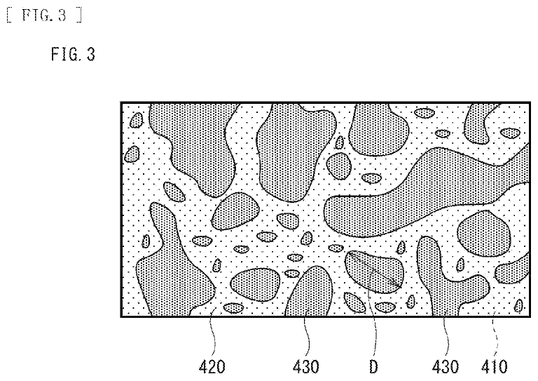

FIG. 3 is a diagram schematically illustrating a surface state of the negative electrode active material particle illustrated in FIG. 2.

### DETAILED DESCRIPTION

One or embodiments of the present technology are described below in further detail including with reference to the drawings.

A description is given first of an alkaline battery according to an embodiment. A method of manufacturing an alkaline battery according to an embodiment is a method of manufacturing the alkaline battery to be described below, and is thus described together below.

FIG. 1 illustrates a sectional configuration of the alkaline battery. The alkaline battery includes a battery can 10, a gasket 20, a positive electrode 30, a negative electrode 40, a separator 50, and a protective layer 60, as illustrated in FIG. 1.

The alkaline battery illustrated in FIG. 1 has a flat and columnar three-dimensional shape. That is, the alkaline battery to be described here is of a so-called coin-type or button-type.

The battery can 10 is a containing member that contains components including, without limitation, the positive electrode 30, the negative electrode 40, and the separator 50. The battery can 10 includes a pair of bowl-like shaped members each having an open end and a closed end. The pair of bowl-like shaped members are a positive electrode container 11 and a negative electrode container 12.

The positive electrode container 11 is a positive electrode containing member that contains the positive electrode 30. The positive electrode container 11 has a substantially cylindrical three-dimensional shape that includes a substantially circular bottom part and a sidewall part. The positive electrode container 11 has an opening 11K that is the open end. Note that because the positive electrode container 11 is adjacent to the positive electrode 30, the positive electrode container 11 also serves as a current collector of the positive electrode 30 and an external coupling terminal of the positive electrode 30. The external coupling terminal of the positive electrode 30 is a so-called positive electrode terminal.

The negative electrode container 12 is a negative electrode containing member that contains the negative electrode 40. As with the positive electrode container 11, the negative electrode container 12 has a substantially cylindrical three-dimensional shape that includes a substantially circular bottom part and a sidewall part. As with the positive electrode container 11, the negative electrode container 12 has an opening 12K that is the open end. Note that because the negative electrode container 12 is adjacent to the negative electrode 40 with the protective layer 60 having electrical conductivity interposed therebetween, the negative electrode container 12 also serves as a current collector of the negative electrode 40 and an external coupling terminal of the negative electrode 40. The external coupling terminal of the negative electrode 40 is a so-called negative electrode terminal.

An inner size of the positive electrode container 11 is greater than an outer size of the negative electrode container 12. Accordingly, in a state where the positive electrode container 11 and the negative electrode container 12 are disposed with the openings 11K and 12K facing each other, the negative electrode container 12 is placed inside the positive electrode container 11.

The positive electrode container 11 includes an electrically conductive material such as a metal material. Specific examples of the metal material include iron, nickel, and stainless steel. The stainless steel is not particularly limited in kind, and specific examples thereof include SUS430. The positive electrode container 11 may have a single-layered structure or a multilayered structure. The positive electrode container 11 may have a surface plated with a metal material. Specific examples of the metal material include nickel.

The negative electrode container 12 includes an electrically conductive material such as a metal material. Specific examples of the metal material include copper, nickel, and stainless steel. The stainless steel is not particularly limited in kind, and specific examples thereof include SUS304. The negative electrode container 12 may have a single-layered structure or a multilayered structure.

More specifically, the negative electrode container 12 may have a multilayered structure in which a nickel layer, a stainless steel layer, and a copper layer are stacked in this order. That is, the negative electrode container 12 may include a so-called three-layered cladding material. In this case, the copper layer that serves as the current collector of the negative electrode 40 is disposed on an inner side, and the nickel layer is disposed on an outer side.

Here, the positive electrode container 11 and the negative electrode container 12 are crimped to each other with the gasket 20 interposed therebetween in a state where the negative electrode container 12 is disposed inside the positive electrode container 11. In this case, an end part of the negative electrode container 12 may extend toward the positive electrode container 11 and then be folded outward to extend away from the positive electrode container 11. The battery can 10 is thus sealed with the components including, without limitation, the positive electrode 30, the negative electrode 40, and the separator 50 contained therein. The battery can 10 formed by means of crimping processing is a so-called crimped can.

The gasket 20 is interposed between the positive electrode container 11 and the negative electrode container 12. The gasket 20 is a ring-shaped sealing member that seals a space between the positive electrode container 11 and the negative electrode container 12. The gasket 20 includes an insulating material such as a polymer compound. Specific examples of the polymer compound include polyethylene, polypropylene, and nylon.

Here, the positive electrode 30 is a coin-shaped pellet. That is, the positive electrode 30 is a positive electrode mixture molded into a coin-shaped pellet. The positive electrode 30 includes a positive electrode active material in a form of particles, that is, positive electrode active material particles. The positive electrode 30 may further include a positive electrode binder.

The positive electrode active material particles each include one or more of materials including, without limitation, silver oxide and manganese dioxide. The positive electrode binder includes one or more of polymer compounds. Specific examples of the polymer compounds include a fluorine-based polymer compound such as polytetrafluoroethylene.

In addition, the positive electrode 30 preferably includes a silver-nickel composite oxide (nickelite). A reason for this is that upon generation of a hydrogen gas caused by a reaction between a zinc-based material included in a negative electrode active material particle to be described later and an alkaline electrolytic solution, the silver-nickel composite oxide absorbs the generated hydrogen gas, suppressing an increase in pressure inside the battery can 10.

A content of the silver-nickel composite oxide in the positive electrode 30 is not particularly limited. The content of the silver-nickel composite oxide in the positive electrode 30 is preferably within a range from 1 mass % to 60 mass % both inclusive, and more preferably, within a range from 5 mass % to 40 mass % both inclusive, in particular. A reason for this is that the increase in pressure inside the battery can 10 is suppressed while a battery capacity is secured.

The positive electrode 30 may further include a positive electrode conductor. A reason for this is that this improves the electrical conductivity of the positive electrode 30. The positive electrode conductor includes one or more of electrically conductive materials including, without limitation, a carbon material. Specific examples of the carbon material include carbon black, graphite, and graphite.

The negative electrode 40 includes a negative electrode active material in a form of particles, that is, negative electrode active material particles. Here, the negative electrode 40 may include the alkaline electrolytic solution and a thickener together with the negative electrode active material particles, and may be in a gel form. That is, the negative electrode 40 is a gel negative electrode mixture.

The negative electrode active material particles as a whole have a composite structure that includes zinc, gallium, and indium as constituent elements. A detailed configuration of the negative electrode 40 including the negative electrode active material particles will be described later with reference to FIG. 2.

The alkaline electrolytic solution includes one or more of aqueous solutions including respective alkali metal hydroxides. The aqueous solution including an alkali metal hydroxide is a solution in which the alkali metal hydroxide is dispersed or dissolved in an aqueous solvent. The aqueous solvent is not particularly limited in kind, and specific examples thereof include pure water and distilled water. The alkali metal hydroxide is not particularly limited in kind, and specific examples thereof include sodium hydroxide and potassium hydroxide. Note that a space inside the battery can 10 may be filled with the alkaline electrolytic solution.

The thickener is a so-called gelling agent. The thickener includes one or more of polymer compounds. The polymer compounds are not particularly limited in kind, and examples thereof include a cellulose-based water-soluble polymer compound and a water-absorbent polymer compound. Specific examples of the polymer compound include carboxymethyl cellulose and sodium polyacrylate.

The separator 50 is interposed between the positive electrode 30 and the negative electrode 40. The positive electrode 30 and the negative electrode 40 are therefore opposed to each other with the separator 50 interposed therebetween. The separator 50 is impregnated with the alkaline electrolytic solution.

The separator 50 may have a single-layered structure or a multilayered structure. In the latter case, the separator 50 may have a multilayered structure, or a three-layered structure, in which a nonwoven fabric, cellophane, and a microporous film (a graft copolymer in which a methacrylic acid is graft-polymerized with polyethylene) are stacked in this order.

The protective layer 60 is an intermediate layer that is interposed between the negative electrode container 12 and the negative electrode 40. Here, the protective layer 60 is provided in such a manner as to cover an inner surface of the negative electrode container 12. More specifically, the protective layer 60 is provided in a region where the negative electrode container 12 and the negative electrode 40 would be in contact with each other if it were not for the protective layer 60. Note that a range to provide the protective layer 60 may be expanded into a region around the region where the negative electrode container 12 and the negative electrode 40 would be in contact with each other.

In a case where the negative electrode container 12 includes a particular metal material (a first metal material) at a surface facing toward the negative electrode 40, the protective layer 60 preferably includes a particular metal material (a second metal material) having a hydrogen overvoltage that is higher than a hydrogen overvoltage of the metal material that the negative electrode container 12 includes at the surface facing toward the negative electrode 40.

That is, in a case where the negative electrode container 12 has a single-layered structure including one metal material, the protective layer 60 preferably includes a metal material having a hydrogen overvoltage that is higher than a hydrogen overvoltage of the material (the metal material) included in the negative electrode container 12.

In a case where the negative electrode container 12 has a multilayered structure including two or more metal materials, the protective layer 60 preferably includes a metal material having a hydrogen overvoltage that is higher than a hydrogen overvoltage of a material (a metal material) included at a surface of the negative electrode container 12.

A reason why the protective layer 60 is interposed between the negative electrode container 12 and the negative electrode 40 is that this suppresses hydrogen gas generation caused by a partial battery reaction between the negative electrode container 12 and the negative electrode active material particles (a zinc-based material to be described later) included in the negative electrode 40.

For example, in a case where the negative electrode container 12 includes the three-layered cladding material (nickel layer/stainless steel layer/copper layer) as described above, the protective layer 60 includes one or more of the metal materials each having a hydrogen overvoltage that is higher than a hydrogen overvoltage of copper. Examples of the metal materials each having the hydrogen overvoltage that is higher than the hydrogen overvoltage of copper include tin, indium, bismuth, and gallium.

FIG. 2 schematically illustrates a sectional configuration of a negative electrode active material particle 400. FIG. 3 schematically illustrates a surface state of the negative electrode active material particle 400 illustrated in FIG. 2. Note that FIG. 3 illustrates a portion of a surface of the negative electrode active material particle 400 in an enlarged manner.

As illustrated in FIGS. 2 and 3, the negative electrode active material particle 400 includes a center part 410, a covering layer 420, and island-form layers 430. In FIG. 3, the covering layer 420 is shaded lightly and each of the island-form layers 430 is shaded darkly.

The center part 410 is a substantially spherical particle, and includes one or more of mercury-free zinc-based materials. The term “zinc-based material” is a generic term for a material that includes zinc as a constituent element. The zinc-based material may be a single substance (zinc), a compound (a zinc compound), or an alloy (a zinc alloy).

The zinc compound is not particularly limited in kind, and specific examples thereof include zinc oxide. The zinc alloy is not particularly limited in kind, and specific examples thereof include an alloy of zinc and one or more of metals including, without limitation, bismuth, indium, and aluminum.

A content of each of bismuth, indium, and aluminum in the zinc alloy is not particularly limited. Specifically, the content of bismuth is within a range from 5 ppm to 200 ppm both inclusive. The content of indium is within a range from 300 ppm to 500 ppm both inclusive. The content of aluminum is within a range from 5 ppm to 100 ppm both inclusive.

The covering layer 420 covers a surface of the center part 410. The covering layer 420 may cover the entire surface of the center part 410, or may cover only a portion of the surface of the center part 410. In the latter case, multiple covering layers 420 that are separated from each other may cover the surface of the center part 410. FIG. 2 illustrates a case where the covering layer 420 covers the entire surface of the center part 410.

The covering layer 420 includes one or more of gallium-based materials. The term “gallium-based material” is a generic term for a material that includes gallium as a constituent element. The gallium-based material may be a single substance (gallium), a compound (a gallium compound), or an alloy (a gallium alloy). The gallium compound is not particularly limited in kind, and specific examples thereof include gallium hydroxide, gallium oxide, and gallium nitride. The gallium alloy is not particularly limited in kind, and specific examples thereof include a gallium-indium alloy, a gallium-bismuth alloy, a gallium-tin alloy, a gallium-zinc alloy, a gallium-indium-tin alloy, a gallium-indium-zinc alloy, and a gallium-indium-bismuth alloy.

The island-form layers 430 are present on a surface of the covering layer 420, and are separated from each other. That is, the island-form layers 430 separated from each other are present on the surface of the covering layer 420.

The island-form layers 430 include one or more of indium-based materials. The term “indium-based material” is a generic term for a material that includes indium as a constituent element. The indium-based material may be a single substance (indium), a compound (an indium compound), or an alloy (an indium alloy). The indium compound is not particularly limited in kind, and specific examples thereof include indium hydroxide, indium oxide, and indium nitride. The indium alloy is not particularly limited in kind, and specific examples thereof include an indium-bismuth alloy, an indium-tin alloy, an indium-zinc alloy, and an indium-magnesium alloy.

A reason why the negative electrode active material particle 400 has the above-described configuration including the center part 410, the covering layer 420, and the island-form layers 430 is that this allows the alkaline battery to have a superior heavy load characteristic.

This is described below in more detail. The surface of the center part 410 (the zinc-based material) is covered with the covering layer 420 (the gallium-based material), and the island-form layers 430 (the indium-based material) are present on the surface of the covering layer 420. The center parts 410 therefore come into contact with each other with the covering layers 420 and the island-form layers 430 interposed therebetween. This increases an area of contact between the negative electrode active material particles 400, which improves electrical conductivity between the negative electrode active material particles 400. In this case, because gallium, which is a liquid metal, has high electrical conductivity in particular, the electrical conductivity between the negative electrode active material particles 400 markedly improves. As a result, the heavy load characteristic of the alkaline battery improves. In particular, because the electrical conductivity between the negative electrode active material particles 400 markedly improves as described above, a superior heavy load characteristic is achievable even if the alkaline battery is used and stored in a severe environment such as a low-temperature environment.

In addition, a superior capacity retention characteristic is also obtainable in the alkaline battery that uses the negative electrode active material particles 400 each including the center part 410, the covering layer 420, and the island-form layers 430.

This is described below in more detail. Because the covering layer 420 (the gallium-based material) having a high hydrogen overvoltage and the island-form layers 430 (the indium-based material) having a high hydrogen overvoltage are provided on the surface of the center part 410 (the zinc-based alloy), hydrogen gas generation is suppressed in the negative electrode active material particles 400. This allows a consumption mode of the negative electrode active material particles 400 to proceed not from the inside but from the surface thereof, which suppresses degradation or destruction of the negative electrode active material particles 400. As a result, the capacity retention rate of the alkaline battery improves.

The negative electrode active material particle 400 preferably has a series of physical properties described below.

A maximum outer size D of the island-form layers 430 is not particularly limited, and is preferably within a range from 1 μm to 10 μm both inclusive, in particular. A reason for this is that the area of contact between the negative electrode active material particles 400 sufficiently increases, and the electrical conductivity between the negative electrode active material particles 400 therefore sufficiently improves.

Here, the maximum outer size D is calculated by the following procedure. First, the negative electrode 40 is collected by disassembling the alkaline battery. Thereafter, the negative electrode active material particles 400 are collected by washing the negative electrode 40 with use of an aqueous solvent such as distilled water, following which the negative electrode active material particles 400 are dried. The washing of the negative electrode 40 includes, for example, dissolving and removing the thickener. Thereafter, an SEM image (see FIG. 3) is acquired by observation of the surface of the negative electrode active material particle 400 with use of a device such as a scanning electron microscope (SEM). In this case, for example, an analytic microscope Phenom ProX manufactured by Phenom-World is used as the SEM. Observation conditions are set as follows: an acceleration voltage is set to 15 key; and an observation magnification is set to 4300 times. Lastly, any five island-form layers 430 are selected on the basis of the SEM image, and the respective maximum outer sizes D (μm) of the selected island-form layers 430 are measured, following which an average value of the measured five maximum outer sizes D is calculated.

An abundance ratio between zinc included in the center part 410 (the zinc-based material) as a constituent element, gallium included in the covering layer 420 (the gallium-based material) as a constituent element, and indium included in the island-form layers 430 (the indium-based material) as a constituent element is not particularly limited.

In particular, an abundance ratio RGZ is preferably within a range from 0.5 to 5.0 both inclusive. The abundance ratio RGZ is a ratio of a content CG (mass %) of gallium at the surface of the negative electrode active material particle 400 to a content CZ (mass %) of zinc at the surface of the negative electrode active material particle 400.

In addition, an abundance ratio RIZ is preferably within a range from 1.0 to 20.0 both inclusive. The abundance ratio RIZ is a ratio of a content CI (mass %) of indium at the surface of the negative electrode active material particle 400 to the above-described content CZ of zinc.

A reason why the abundance ratios RGZ and RIZ are within the respective ranges described above is that the electrical conductivity between the negative electrode active material particles 400 is improved while degradation of the negative electrode active material particles 400 is suppressed. The abundance ratio RGZ is calculated on the basis of the following calculation expression: RGZ=(CG/CZ)×100. The abundance ratio RIZ is calculated on the basis of the following calculation expression: RIZ=(CI/CZ)×100.

In this case, an abundance ratio RIG is preferably within a range from 0.5 to 8.5 both inclusive. The abundance ratio RIG is a ratio of the content CI of indium to the content CG of gallium.

A reason for this is that the electrical conductivity between the negative electrode active material particles 400 is sufficiently improved while the degradation of the negative electrode active material particles 400 is sufficiently suppressed. The abundance ratio RIG is calculated on the basis of the following calculation expression: RIG=(CI/CG)×100.

In particular, the abundance ratio RGZ is more preferably within a range from 1.0 to 3.0 both inclusive, and the abundance ratio RIZ is more preferably within a range from 2.0 to 18.0 both inclusive. In this case, the abundance ratio RIG is more preferably within a range from 2.0 to 8.5 both inclusive. A reason for this is that the electrical conductivity between the negative electrode active material particles 400 is further improved while the degradation of the negative electrode active material particles 400 is further suppressed.

Here, a procedure for calculating the abundance ratio RGZ is as described below. First, multiple negative electrode active material particles 400 are collected from the alkaline battery by the above-described procedure. Thereafter, the surface of the negative electrode active material particle 400 is observed with use of an SEM. Details, including the observation conditions, are as described above. Thereafter, the contents CZ and CG are each determined by performing elemental analysis of the surface of the negative electrode active material particle 400 by energy dispersive X-ray spectrometry (EDX). As the analysis condition, the acceleration voltage is set to 15 keV.

In a case of determining the content CZ, first, an EDX spectrum of the surface of the negative electrode active material particle 400 is acquired, following which a peak intensity I(Zn) unique to zinc is determined. Thereafter, the peak intensity I(Zn) is corrected on the basis of a ratio I(Zn)/Is(Zn) which is a ratio of the peak intensity I(Zn) to a peak intensity Is(Zn) of a standard sample. Lastly, the content CZ is determined on the basis of the corrected peak intensity I(Zn).

In a case of determining the content CG, first, an EDX spectrum of the surface of the negative electrode active material particle 400 is acquired, following which a peak intensity I(Ga) unique to gallium is determined. Thereafter, the peak intensity I(Ga) is corrected on the basis of a ratio I(Ga)/Is(Ga) which is a ratio of the peak intensity I(Ga) to a peak intensity Is(Ga) of a standard sample. Lastly, the content CG is determined on the basis of the corrected peak intensity I(Ga).

Lastly, the abundance ratio RGZ is calculated on the basis of the contents CZ and CG.

A procedure for calculating the abundance ratio RIZ is similar to the procedure for calculating the abundance ratio RGZ except for using the abundance CI in place of the abundance CG. In a case of determining the content CI, first, an EDX spectrum of the surface of the negative electrode active material particle 400 is acquired, following which a peak intensity I(In) unique to indium is determined. Thereafter, the peak intensity I(In) is corrected on the basis of a ratio I(In)/Is(In) which is a ratio of the peak intensity I(In) to a peak intensity Is(In) of a standard sample. Lastly, the content CI is determined on the basis of the corrected peak intensity I(In).

A procedure for calculating the abundance ratio RIG is similar to the procedure for calculating the abundance ratio RGZ except for using the abundance CI in place of the abundance CZ.

The alkaline battery is manufactured by the following procedure. In this case, the positive electrode 30 and the negative electrode 40 are each fabricated, following which the alkaline battery is assembled using components including, without limitation, the fabricated positive electrode 30 and negative electrode 40.

First, the positive electrode active material is mixed with the positive electrode binder on an as-needed basis to thereby obtain a positive electrode mixture. Thereafter, the positive electrode mixture is molded into a coin shape by means of a press molding machine. Lastly, the positive electrode mixture having the coin shape is placed in the positive electrode container 11, following which the alkaline electrolytic solution is injected into the positive electrode container 11. The positive electrode mixture is thereby impregnated with the alkaline electrolytic solution. The positive electrode 30 is thus fabricated.

The zinc-based material in a powder form (the zinc-based material particles), the alkaline electrolytic solution, the thickener, and a liquid metal alloy which is an additive material are prepared as raw materials.

The additive material is a material to be added to the zinc-based material particles, the alkaline electrolytic solution, and the thickener. The additive material is a material to form each of the covering layer 420 and the island-form layers 430. The liquid metal alloy which is the additive material is an alloy of gallium (a liquid metal) and indium, and therefore includes gallium and indium as constituent elements.

Specifically, the liquid metal alloy may be an alloy of gallium and indium, or an alloy of gallium, indium, and one or more of other metals (metals other than gallium and indium). The other metals are not particularly limited in kind, and specific examples thereof include tin, zinc, and bismuth.

The liquid metal alloy is not particularly limited in composition (weight ratio between metal components). In a case where the liquid metal alloy is the alloy of gallium and indium, in particular, it is preferable that a content of gallium be greater than a content of indium. In a case where the liquid metal alloy is the alloy of gallium, indium, and one or more of the other metals, it is preferable that a content of gallium be greater than a content of indium and that the content of indium be greater than a total content of the one or more other metals. A reason for this is that this allows the covering layer 420 to be easily formed in such a manner as to cover the surface of the center part 410 and also allows the island-form layers 430 to be easily formed in such a manner as to be present on the surface of the covering layer 420.

Thereafter, the raw materials are mixed with each other while being heated to thereby form a negative electrode mixture. A heating temperature is not particularly limited. Specifically, the heating temperature is within a range from 30° C. to 80° C. both inclusive, preferably, within a range from 35° C. to 80° C. both inclusive, and more preferably, within a range from 40° C. to 80° C. both inclusive.

This allows the thickener to be dissolved in the alkaline electrolytic solution, which improves a binding property of the thickener. As a result, viscosity of the negative electrode mixture increases. In addition, the liquid metal alloy easily adheres to the entire surface of the center part 410 (the zinc-based material particles), which allows for easier precipitation of the gallium-based material on the surface of the center part 410 over a wide range. As a result, the covering layer 420 (the gallium-based material) is formed. In addition, precipitation of the indium-based material is made easier partially on the surface of the covering layer 420 (the gallium-based material). As a result, the island-form layers 430 (the indium-based material) are formed.

In such a manner, the center part 410 (the zinc-based material), the covering layer 420 (the gallium-based material), and the island-form layers 430 (the indium-based material) are formed, and the negative electrode active material particles 400 are thereby formed. The negative electrode 40 in a gel form including the negative electrode active material particles 400 is thus fabricated.

First, the separator 50 is placed on the positive electrode 30 contained in the positive electrode container 11, following which the alkaline electrolytic solution is dropped onto the separator 50. The separator 50 is thus impregnated with the alkaline electrolytic solution.

Thereafter, the negative electrode 40 in the gel form is placed on the separator 50, following which the negative electrode container 12 is placed on the negative electrode 40. In this case, the negative electrode container 12 is disposed with respect to the positive electrode container 11 in such a manner that the openings 11K and 12K face each other, and the negative electrode container 12 is placed inside the positive electrode container 11 with the gasket 20 interposed therebetween. Note that because the protective layer 60 is formed on the inner surface of the negative electrode container 12 by a method such as sputtering, the negative electrode container 12 is adjacent to the negative electrode 40 with the protective layer 60 interposed therebetween.

Lastly, the positive electrode container 11 and the negative electrode container 12 are crimped to each other with the gasket 20 interposed therebetween to form the battery can 10. This seals the components including, without limitation, the positive electrode 30, the negative electrode 40, and the separator 50 in the battery can 10. The alkaline battery is thus completed.

According to the alkaline battery, the negative electrode active material particle 400 of the negative electrode 40 includes the center part 410 (the zinc-based material), the covering layer 420 (the gallium-based material), and the island-form layers 430 (the indium-based material).

In this case, as described above, the center parts 410 come into contact with each other with the covering layers 420 and the island-form layers 430 interposed therebetween, which increases the area of contact between the negative electrode active material particles 400. As a result, electrical conductivity between the negative electrode active material particles 400 improves. In this case, because gallium, which is a liquid metal, has high electrical conductivity in particular, the electrical conductivity between the negative electrode active material particles 400 markedly improves. Accordingly, it is possible to achieve a superior heavy load characteristic.

In particular, the maximum outer size D of the island-form layers 430 may be within the range from 1 μm to 10 μm both inclusive. This improves the electrical conductivity between the negative electrode active material particles 400. Accordingly, it is possible to achieve higher effects.

In addition, the abundance ratio RGZ may be within the range from 0.5 to 5.0 both inclusive, and the abundance ratio RIZ may be within the range from 1.0 to 20.0 both inclusive. This improves the electrical conductivity between the negative electrode active material particles 400 while suppressing degradation of the negative electrode active material particles 400. Accordingly, it is possible to achieve higher effects. In this case, the abundance ratio RIG may be within the range from 0.5 to 8.5 both inclusive. This makes it possible to achieve further higher effects.

In particular, the abundance ratio RGZ may be within the range from 1.0 to 3.0 both inclusive and the abundance ratio RIZ may be within the range from 2.0 to 18.0 both inclusive. This further improves the electrical conductivity between the negative electrode active material particles 400 while further suppressing the degradation of the negative electrode active material particles 400. Accordingly, it is possible to achieve further higher effects. In this case, the abundance ratio RIG may be within the range from 2.0 and 8.5 both inclusive. This makes it possible to achieve markedly high effects.

Further, the negative electrode 40 may include the alkaline electrolytic solution and the thickener together with the negative electrode active material particles 400 and may be in the gel form. This allows for easier formation of the negative electrode active material particles 400 having the above-described configuration (the center part 410, the covering layer 420, and the island-form layers 430) and makes it easier for the alkaline electrolytic solution to be held in the negative electrode 40. Accordingly, it is possible to achieve higher effects.

Further, the protective layer 60 may be interposed between the negative electrode container 12 and the negative electrode 40, and the protective layer 60 may include the metal material having the hydrogen overvoltage that is higher than the hydrogen overvoltage of the metal material at the surface of the negative electrode container 12. This suppresses hydrogen gas generation caused by a side reaction between the negative electrode container 12 and the negative electrode 40 (the zinc-based material). Accordingly, it is possible to achieve higher effects.

Other than the above, according to the method of manufacturing the alkaline battery, in forming the negative electrode 40 (the negative electrode active material particles 400), the zinc-based material in a powder form (the zinc-based material particles), the alkaline electrolytic solution, the thickener, and the liquid metal alloy (the alloy of gallium, which is a liquid metal, and indium) are mixed with each other.

In this case, as described above, while the viscosity of the negative electrode mixture is increased with use of the thickener, the gallium-based material is easily precipitated on the surface of the center part 410 (the zinc-based material) over a wide range, which allows for formation of the covering layer 420 (the gallium-based material). In addition, the indium-based material is easily precipitated partially on the surface of the covering layer 420 (the gallium-based material), which allows for formation of the island-form layers 430 (the indium-based material). Accordingly, the negative electrode active material particles 400 each including the center part 410 (the zinc-based material), the covering layer 420 (the gallium-based material), and the island-form layers 430 (the indium-based material) are easily formed. As a result, it is possible to manufacture an alkaline battery having a superior heavy load characteristic.

The configuration of the alkaline battery is appropriately modifiable, as described below.

In FIG. 1, the protective layer 60 is provided on the inner surface of the negative electrode container 12. However, no protective layer 60 may be provided on the inner surface of the negative electrode container 12. In this case also, a superior heavy load characteristic is achievable and similar effects are therefore achievable if the negative electrode active material particle 400 of the negative electrode 40 includes the center part 410, the covering layer 420, and the island-form layers 430. Note that in order to suppress the hydrogen gas generation caused by the side reaction between the negative electrode container 12 and the negative electrode 40 (the zinc-based material), it is preferable that the protective layer 60 be provided on the inner surface of the negative electrode container 12 as described above.

### EXAMPLES

Examples of the present technology will be described according to an embodiment.

### Examples 1 to 18 and Comparative Examples 1 to 4

Alkaline batteries were manufactured, and thereafter the alkaline batteries were evaluated for their respective battery characteristics.

### [Manufacturing of Alkaline Battery]

The alkaline batteries illustrated in FIG. 1 were manufactured in accordance with the following procedure.

### (Fabrication of Positive Electrode)

First, 69.5 parts by mass of the positive electrode active material (silver oxide), 20.0 parts by mass of the positive electrode active material (manganese dioxide), 10.0 parts by mass of the silver-nickel composite oxide (nickelite), and 0.5 parts by mass of the positive electrode binder (polytetrafluoroethylene) were mixed with each other to thereby obtain a positive electrode mixture. Thereafter, the positive electrode mixture was molded into a coin shape by means of a press molding machine. Lastly, the positive electrode mixture of the coin shape was placed in the positive electrode container 11 (SUS430), following which the alkaline electrolytic solution (an aqueous solution of sodium hydroxide at a concentration of 25%) was injected into the positive electrode container 11. The positive electrode mixture was thus impregnated with the alkaline electrolytic solution. In this manner, the positive electrode 30 was fabricated.

### (Fabrication of Negative Electrode)

The negative electrode 40 was fabricated using the liquid metal alloy as the additive material.

Specifically, a mercury-free zinc-based material in a powder form (zinc alloy particles), the alkaline electrolytic solution (the above-described aqueous solution of sodium hydroxide), the thickener (carboxymethylcellulose), and the liquid metal alloy (a gallium alloy) as the additive material were prepared as raw materials.

As the zinc alloy, a zinc-aluminum-bismuth-indium alloy was used. A content of aluminum was set within a range from 5 ppm to 100 ppm both inclusive, a content of bismuth was set within a range from 5 ppm to 200 ppm both inclusive, and a content of indium was set within a range from 300 ppm to 500 ppm both inclusive.

As the gallium alloy, a gallium-indium alloy (GaIn), a gallium-indium-tin alloy (GaInSn), and a gallium-indium-zinc alloy (GaInZn) were used. A composition of the gallium-indium alloy was so set that a weight ratio of gallium to indium was set to 75.5:24.5. A composition of the gallium-indium-tin alloy was so set that a weight ratio of gallium to indium to tin was set to 62:25:13. A composition of the gallium-indium-zinc alloy was so set that a weight ratio of gallium to indium to zinc was set to 67:29:4.

Thereafter, the raw materials were mixed with each other while being heated (at a heating temperature of 45° C.), to thereby obtain a negative electrode mixture. In this case, 68.0 parts by mass of a mercury-free zinc-based material in a power form, 25.0 parts by mass of the alkaline electrolytic solution, 6.9 parts by mass of the thickener, and 0.1 parts by mass of the liquid metal alloy as the additive material were mixed with each other.

The negative electrode active material particles 400 each including the center part 410 (the zinc-based material), the covering layer 420 (the gallium-based material), and the island-form layers 430 (the indium-based material) were thus formed. In this manner, the negative electrode 40 in the gel form including the negative electrode active material particles 400 was fabricated.

After the negative electrode 40 was fabricated, physical properties of the negative electrode active material particle 400 (the maximum outer size D (μm) and the abundance ratios RGZ, RIZ, and RIG) were examined, which revealed the results presented in Table 1. The procedure for examining each of the maximum outer size D and the abundance ratios RGZ, RIZ, and RIG was as described above. In this case, each of the maximum outer size D and the abundance ratios RGZ, RIZ, and RIG was varied by changing factors such as an addition amount of the liquid metal alloy which was the additive material.

For comparison, the negative electrode 40 was fabricated by a similar procedure except for not using the liquid metal alloy which was the additive material. For comparison, the negative electrode 40 was further fabricated by a similar procedure except for using an indium compound (indium hydroxide (In(OH)₃) in a powder form and a gallium compound (gallium hydroxide (Ga(OH)₃) in a powder form as the additive material in place of the liquid metal alloy. Each of the maximum outer size D and the abundance ratios RGZ, RIZ, and RIG was also examined in these cases in a similar manner, which revealed the results presented in Table 2.

### (Assembly of Alkaline Battery)

First, the separator 50 having a circular shape was placed on the positive electrode 30 contained in the positive electrode container 11. Thereafter, the alkaline electrolytic solution (the aqueous solution of sodium hydroxide described above) was dropped onto the separator 50 to impregnate the separator 50 with the alkaline electrolytic solution. As the separator 50, a multilayered film in which a nonwoven fabric, cellophane, and a microporous film graft-polymerized with polyethylene were stacked in this order was used.

Thereafter, the negative electrode 40 in the gel form was placed on the separator 50, following which the negative electrode container 12 (SUS304) was placed on the negative electrode 40. In this case, the negative electrode container 12 was placed inside the positive electrode container 11 with the gasket 20 (a nylon film) interposed therebetween.

Lastly, the positive electrode container 11 and the negative electrode container 12 were crimped to each other with the gasket 20 interposed therebetween to form the battery can 10. In such a manner, the alkaline battery was completed.

### [Evaluation of Battery Characteristic]

The alkaline batteries were evaluated for their respective battery characteristics (a heavy load characteristic and a capacity retention characteristic), which revealed the results presented in Tables 1 and 2. In each of Tables 1 and 2, the column of “covering layer/gallium-based material” indicates whether the covering layer 420 was present, and the column of the “island-form layer/indium-based material” indicates whether the island-form layers 430 were present.

### (Heavy Load Characteristic)

A voltage (a closed circuit voltage (CCV)) of the alkaline battery was measured five seconds after a load of 2 kΩ was applied in a low-temperature environment (at a temperature of −10° C.). In this case, five alkaline batteries were used and the above-described operation of measuring the closed circuit voltage was therefore repeated five times. An average value of the five closed circuit voltages was thereby calculated. Note that values of the closed circuit voltages listed in each of Tables 1 and 2 are normalized values each obtained with respect to the value of the closed circuit voltage of Comparative example 1, which used no additive material, assumed as 100.0%.

### (Capacity Retention Characteristic)

First, the alkaline battery to which a load of 30 kΩ was applied was discharged in an ambient temperature environment (at a temperature of 23° C.) until a voltage reached 1.4 V to thereby measure a discharge capacity (a pre-storage discharge capacity). In this case, five alkaline batteries were used and the above-described operation of measuring the discharge capacity was therefore repeated five times. An average value of the five discharge capacities was thereby calculated.

Thereafter, the alkaline battery was stored (for a storage period of 100 days) in a high-temperature environment (at a temperature of 60° C.), following which the alkaline battery to which a load of 30 kΩ was applied was discharged until the voltage reached 1.4 V to thereby measure a discharge capacity (a post-storage discharge capacity). In this case, the five alkaline batteries were used, and the above-described operation of measuring the discharge capacity was therefore repeated five times. An average value of the five discharge capacities was thereby calculated.

Lastly, the capacity retention rate was calculated on the basis of the following calculation expression: capacity retention rate=(post-storage discharge capacity/pre-storage discharge capacity)×100. Note that as with the values of the closed circuit voltages described above, the values of the capacity retention rates listed in each of Tables 1 and 2 are normalized values each obtained with respect to the value of the capacity retention rate of Comparative example 1 assumed as 100.0%.

TABLE 1

| | | | | Island- | | | | | | |
|---|---|---|---|---|---|---|---|---|---|---|
| | | Center | Covering | form | | | | | | |
| | | part | layer | layer | Maximum | | | | Closed | Capacity |
| | | Zinc- | Gallium- | Indium- | outer | Abundance | Abundance | Abundance | circuit | retention |
| | Additive | based | based | based | size D | ratio | ratio | ratio | voltage | rate |
| | material | material | material | material | (μm) | RGZ | RIZ | RIG | (normalized) | (normalized) |
| Example 1 | Liquid | Zinc | Present | Present | 0.1 | 0.2 | 0.3 | 1.5 | 100.1 | 100.2 |
| Example 2 | metal | alloy | | | 1 | 0.7 | 1.2 | 1.7 | 100.4 | 101.3 |
| Example 3 | alloy | | | | 2 | 1.0 | 2.5 | 2.5 | 101.1 | 102.7 |
| Example 4 | (GaIn) | | | | 8 | 3.0 | 17.5 | 5.8 | 101.4 | 104.1 |
| Example 5 | | | | | 10 | 4.5 | 19.5 | 4.3 | 103.7 | 101.0 |
| Example 6 | | | | | 10 | 6.5 | 24.0 | 3.7 | 104.0 | 95.2 |
| Example 7 | Liquid | Zinc | Present | Present | 0.1 | 0.1 | 0.3 | 0.3 | 100.0 | 100.1 |
| Example 8 | metal | alloy | | | 1 | 0.5 | 1.0 | 0.5 | 100.6 | 100.4 |
| Example 9 | alloy | | | | 2 | 1.0 | 2.0 | 2.0 | 100.9 | 102.4 |
| Example 10 | (GaInSn) | | | | 8 | 2.0 | 17.0 | 8.5 | 101.9 | 105.3 |
| Example 11 | | | | | 10 | 4.0 | 19.0 | 4.8 | 102.2 | 100.6 |
| Example 12 | | | | | 10 | 5.4 | 21.0 | 3.9 | 102.5 | 90.7 |
| Example 13 | Liquid | Zinc | Present | Present | 0.1 | 0.2 | 0.3 | 1.5 | 100.1 | 100.1 |
| Example 14 | metal | alloy | | | 1 | 0.5 | 1.0 | 2.0 | 100.7 | 100.5 |
| Example 15 | alloy | | | | 2 | 1.0 | 2.0 | 2.0 | 101.1 | 103.5 |
| Example 16 | (GaInSn) | | | | 8 | 3.0 | 18.0 | 6.0 | 103.3 | 103.4 |
| Example 17 | | | | | 10 | 5.0 | 20.0 | 4.0 | 103.6 | 100.3 |
| Example 18 | | | | | 10 | 5.8 | 22.0 | 3.8 | 103.8 | 97.0 |

TABLE 2

| | | | | Island- | | | | | | |
|---|---|---|---|---|---|---|---|---|---|---|
| | | Center | Covering | form | | | | | | |
| | | part | layer | layer | Maximum | | | | Closed | Capacity |
| | | Zinc- | Gallium- | Indium- | outer | Abundance | Abundance | Abundance | circuit | retention |
| | Additive | based | based | based | size D | ratio | ratio | ratio | voltage | rate |
| | Material | material | material | material | (μm) | RGZ | RIZ | RIG | (%) | (%) |
| Comparative | — | Zinc | Absent | Absent | — | — | — | — | 100.0 | 100.0 |
| example 1 | | alloy | | | | | | | | |
| Comparative | Indium | Zinc | Absent | Present | 10 | — | 9.3 | — | 98.4 | 103.6 |
| example 2 | compound | alloy | | | | | | | | |
| Comparative | (In(OH)₃) | Zinc | Absent | Present | 10 | — | 12.2 | — | 99.4 | 103.7 |
| example 3 | | alloy | | | | | | | | |
| Comparative | Gallium | Zinc | Present | Absent | — | 1.8 | — | — | 99.1 | 100.6 |
| example 4 | compound | alloy | | | | | | | | |
| | (Ga(OH)₃) | | | | | | | | | |

As indicated in Tables 1 and 2, the closed circuit voltage greatly varied depending on the surface state of the negative electrode active material particle 400. The following comparisons were made to the closed circuit voltage of Comparative example 1 in which neither the covering layer 420 (the gallium-based material) nor the island-form layers 430 (the indium-based material) were formed on the surface of the center part 410 (the zinc-based material) due to absence of the additive material.

Specifically, in a case where the indium compound was used as the additive material (Comparative examples 2 and 3), the island-form layers 430 were formed on the surface of the center part 410 but no covering layer 420 was formed on the surface of the center part 410. Accordingly, the closed circuit voltage decreased.

In a case where the gallium compound was used as the additive material (Comparative example 4), as with the above-described case where the indium compound was used, the island-form layers 430 were formed on the surface of the center part 410 but no covering layer 420 was formed on the surface of the center part 410. Accordingly, the closed circuit voltage decreased.

In contrast, in a case where the liquid metal alloy was used as the additive material (Examples 1 to 18), both the covering layer 420 and the island-form layers 430 were formed on the surface of the center part 410. Accordingly, the closed circuit voltage increased.

In particular, in a case where the negative electrode active material particles 400 each included the center part 410, the covering layer 420, and the island-form layers 430, the series of tendencies described below were obtained.

Firstly, the closed circuit voltage increased sufficiently if the maximum outer size D was within a range from 1 μm to 10 μm both inclusive.

Secondly, the capacity retention rate increased if the abundance ratio RGZ was within a range from 0.5 to 5.0 both inclusive and the abundance ratio RIZ was within a range from 1.0 to 20.0 both inclusive. In this case, a sufficient capacity retention rate was obtained if the abundance ratio RIG was within a range from 0.5 to 8.5 both inclusive.

Thirdly, the capacity retention rate further increased if the abundance ratio RGZ was within a range from 1.0 to 3.0 both inclusive and the abundance ratio RIZ was within a range from 2.0 to 18.0 both inclusive. In this case, a sufficient capacity retention rate was obtained if the abundance ratio RIG was within a range from 2.0 to 8.5 both inclusive.

Based upon the results presented in Tables 1 and 2, if the negative electrode active material particle 400 of the negative electrode 40 included the center part 410 (the zinc-based material), the covering layer 420 (the gallium-based material), and the island-form layers 430 (the indium-based material), the closed circuit voltage increased. Accordingly, the alkaline battery achieved a superior heavy load characteristic.

Although the technology has been described above with reference to some embodiments and Examples, the configuration of the technology is not limited to those described with reference to the embodiments and Examples above, and is therefore modifiable in a variety of ways.

Specifically, the description has been given of a case where the alkaline battery has a battery structure of the coin type or the button type. However, the battery structure of the alkaline battery is not particularly limited, and may be of any other type, such as a cylindrical type or a prismatic type.

The effects described herein are mere examples, and effects of the present technology are therefore not limited thereto and may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An alkaline battery comprising
a negative electrode including a negative electrode active material particle, wherein
the negative electrode active material particle includes
a center part that includes zinc as a constituent element,
a covering layer that covers a surface of the center part and includes gallium as a constituent element, and
island-form layers that are present on a surface of the covering layer and include indium as a constituent element.

2. The alkaline battery according to claim 1, wherein the island-form layers have a maximum outer size that is greater than or equal to 1 micrometer and less than or equal to 10 micrometers.

3. The alkaline battery according to claim 1, wherein
a ratio of a content in mass percent of the gallium at a surface of the negative electrode active material particle to a content in mass percent of the zinc at the surface of the negative electrode active material particle is greater than or equal to 0.5 and less than or equal to 5.0, and
a ratio of a content in mass percent of the indium at the surface of the negative electrode active material particle to the content in mass percent of the zinc at the surface of the negative electrode active material particle is greater than or equal to 1.0 and less than or equal to 20.0.

4. The alkaline battery according to claim 3, wherein a ratio of the content in mass percent of the indium at the surface of the negative electrode active material particle to the content in mass percent of the gallium at the surface of the negative electrode active material particle is greater than or equal to 0.5 and less than or equal to 8.5.

5. The alkaline battery according to claim 3, wherein
the ratio of the content of the gallium to the content of the zinc is greater than or equal to 1.0 and less than or equal to 3.0, and
the ratio of the content of the indium to the content of the zinc is greater than or equal to 2.0 and less than or equal to 18.0.

6. The alkaline battery according to claim 5, wherein a ratio of the content of the indium to the content of the gallium is greater than or equal to 2.0 and less than or equal to 8.5.

7. The alkaline battery according to claim 1, wherein
the negative electrode further includes an alkaline electrolytic solution and a thickener and is in a gel form,
the alkaline electrolytic solution includes an aqueous solution including an alkali metal hydroxide, and
the thickener includes a polymer compound.

8. The alkaline battery according to claim 7, further comprising
a negative electrode containing member that contains the negative electrode; and
an intermediate layer interposed between the negative electrode and the negative electrode containing member, wherein
the negative electrode containing member includes a first metal material at a surface facing toward the negative electrode, and
the intermediate layer includes a second metal material, the second metal material having a hydrogen overvoltage that is higher than a hydrogen overvoltage of the first metal material.

9. A method of manufacturing an alkaline battery, the method comprising,
in forming a negative electrode including a negative electrode active material particle,
mixing a particle, an alkaline electrolytic solution, a thickener, and a liquid metal alloy with each other,
the particle including zinc as a constituent element,
the alkaline electrolytic solution including an aqueous solution including an alkali metal hydroxide,
the thickener including a polymer compound,
the liquid metal alloy including gallium and indium as constituent elements.
